(19) United States
(12) Patent Application Publication
(10) Pub. No.: US 2017/0341401 A1
(43) Pub. Date: Nov. 30, 2017

(54) FLOW PATH JOINT AND LIQUID EJECTING APPARATUS

(71) Applicant: SEIKO EPSON CORPORATION, Tokyo (JP)

(72) Inventor: Fujio AKAHANE, Azumino-shi (JP)

(21) Appl. No.: 15/596,211

(22) Filed: May 16, 2017

(30) Foreign Application Priority Data
May 30, 2016 (JP) 2016-107344

(51) Int. Cl. B41J 2/175; F16L 21/02

(52) U.S. Cl. CPC B41J 2/175; F16L 21/02

(57) ABSTRACT

A flow path joint, which connects a first flow path inside a tubular body to a second flow path inside a flow path member, includes an elastic member that is able to elastically change shape, and a support body that supports the elastic member, in which the elastic member includes a press fitting portion which is a tubular shape part that is linked to the second flow path and into which the tubular body is press fitted, and a sealing portion that is interposed between the support body and the flow path member.

### BACKGROUND

### 1. Technical Field

The present invention relates to a structure for connecting a plurality of flow paths to each other.

### 2. Related Art

Various structures for connecting a plurality of flow paths to each other are suggested from the related art. For example, a configuration is disclosed in JP-A-2012-148411 in which a flow path of an inflow flow path portion and a flow path of an ink supply pipe are connected to each other by inserting the ink supply pipe into an annular sealing member that is held in the inflow flow path portion (holder).

However, in the technique in JP-A-2012-148411, for example, it is possible to form a gap (step) between the inflow flow path portion and the sealing portion in a state in which the ink supply pipe is not sufficiently inserted with respect to the inflow flow path portion. Accordingly, there is a problem in that air bubbles that are mixed in liquid that flows in the flow path tends to be retained in the gap.

### SUMMARY

An advantage of some aspects of the invention is to suppress retention of air bubbles in a part that is connected to a plurality of flow paths.

### Aspect 1

According to a preferred aspect of the invention (Aspect 1), there is provided a flow path joint, which connects a first flow path inside a tubular body to a second flow path inside a flow path member, including an elastic member that is able to elastically change shape, and a support body that supports the elastic member, in which the elastic member includes a press fitting portion which is a tubular shape part that is linked to the second flow path and into which the tubular body is press fitted, and a sealing portion that is interposed between the support body and the flow path member. In Aspect 1, a gap between the elastic member and the flow path member is reduced since the sealing portion of the elastic member is interposed between the support body and the flow path member. Accordingly, it is possible to suppress retention of air bubbles in a part that connects the first flow path and the second flow path.

### Aspect 2

In a preferred example of Aspect 1 (Aspect 2), the elastic member may include a pipe internal projecting portion that is formed on the inner wall surface of the press fitting portion along a peripheral direction of the press fitting portion. In Aspect 2, it is possible to secure sealability between the elastic member and the tubular body while suppressing external force that is necessary in press fitting of the tubular body with respect to the press fitting portion since the pipe internal projecting portion is formed on the inner wall surface of the press fitting portion.

### Aspect 3

The flow path joint according to a preferred example of Aspect 1 or Aspect 2 (Aspect 3) may include a fixing portion for fixing the support body and the flow path member. In Aspect 3, it is advantageous for disposition of the elastic member to be easy (has good assembly) in comparison to a configuration in which the flow path member and the support body are integrally formed since the flow path member and the support body are fixed separately from each other.

### Aspect 4

In a preferred example of any one of Aspect 1 to Aspect 3 (Aspect 4), a difference between an inner diameter of the press fitting portion and an inner diameter of the second flow path may be lower than a difference between an outer diameter of a part that is press fitted into the press fitting portion out of the tubular body and the inner diameter of the press fitting portion. In Aspect 4, since a difference between the inner diameter of the press fitting portion and the inner diameter of the second flow path is reduced, it is possible to reduce a possibility that air bubbles are retained in a step that is caused by the difference.

### Aspect 5

In a preferred example of any one of Aspect 1 to Aspect 4 (Aspect 5), the sealing portion may include a base portion that projects from an outer wall surface of the press fitting portion and a projecting portion that projects from a front surface on the opposite side from the press fitting portion out of the base portion and that contacts the flow path member. In Aspect 5, since the sealing portion includes the base portion and the projecting portion, it is possible to secure sealability of the elastic member and the support body while sufficiently reducing a gap between the elastic member and the flow path member.

### Aspect 6

In a preferred example of any one of Aspect 1 to Aspect 5 (Aspect 6), the press fitting portion may be disposed at a position that is separated from the support body, and the elastic member may include a holding portion that is supported on the support body at the tubular body side viewed from the press fitting portion. In Aspect 6, it is possible for the press fitting portion to change shape according to the position of the tubular body since the press fitting portion out of the elastic member, into which the tubular body is press fitted is disposed at a position that is separated from the support body. That is, positional error between the first flow path and the second flow path is absorbed because of the change of shape of the press fitting portion. Accordingly, it is possible to enlarge the permissible range of the positional error between the first flow path and the second flow path. Meanwhile, it is possible to suppress buckling of the elastic member when the tubular body is press fitted in the press fitting portion since the holding portion of the elastic member is supported on the support body at the tubular body side viewed from the press fitting portion.

### Aspect 7

According to another preferred aspect of the invention (Aspect 7), there is provided a liquid ejecting apparatus including a liquid ejecting head that ejects liquid, a tubular body on which a first flow path is formed for supplying liquid to the liquid ejecting head, and a flow path joint that connects a second flow path internal to a flow path member to the first flow path, in which the flow path joint includes an elastic member that is able to elasticity change shape, and a support body that supports the elastic member, and the elastic member includes a press fitting portion which is a tubular shape part that is linked to the second flow path and into which the tubular body is press fitted, and a sealing portion that is interposed between the support body and the flow path member.

### BRIEF DESCRIPTION OF THE DRAWINGS

The invention will be described with reference to the accompanying drawings, wherein like numbers reference like elements.

FIG. 1 is a configuration diagram of a liquid ejecting head according to a first embodiment.

FIG. 2 is a sectional view of a state in which a tubular body and a flow path member are connected by a flow path joint.

FIG. 3 is a sectional view in which each component in FIG. 2 is disassembled.

FIG. 4 is an explanatory diagram of a positional error in a Z direction between the tubular body and the flow path member.

FIG. 5 is an explanatory diagram of the positional error on an X-Y plane between the tubular body and the flow path member.

FIG. 6 is a sectional view of the flow path joint in a second embodiment.

FIG. 7 is a sectional view of the flow path joint in a modification example in the second embodiment.

FIG. 8 is a sectional view of a flow path joint in a third embodiment.

FIG. 9 is a sectional view of a flow path joint in a fourth embodiment.

FIG. 10 is a sectional view of a state in which a first tubular body and a second tubular body are connected by the flow path joint in the fourth embodiment.

FIG. 11 is a sectional view of a case where there is a positional error between the first tubular body and the second tubular body.

FIG. 12 is a sectional view of a flow path joint in a modification example.

FIG. 13 is a sectional view of a flow path joint in a modification example.

### DESCRIPTION OF EXEMPLARY EMBODIMENTS

### First Embodiment

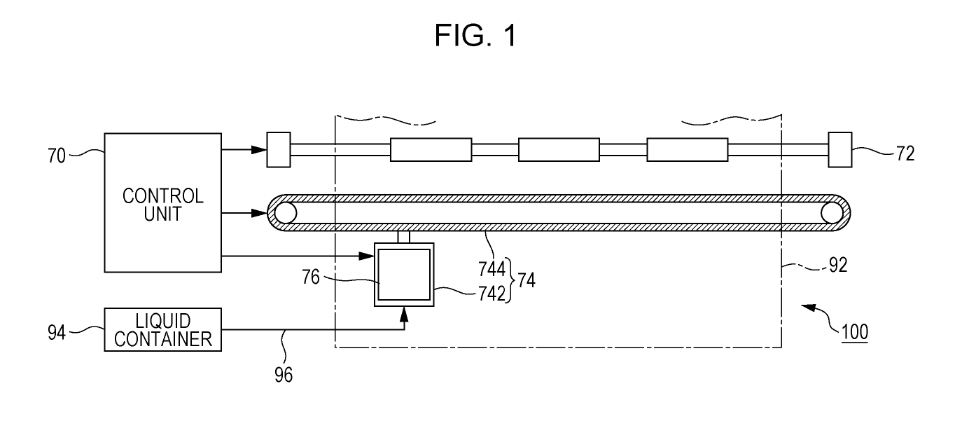

FIG. 1 is a schematic view that exemplifies a liquid ejecting apparatus 100 according to a first embodiment of the invention. The liquid ejecting apparatus 100 in the first embodiment is an ink jet type printing apparatus that ejects ink that is an example of liquid on a medium 92. The medium 92 is typically printing paper, and an arbitrary target for printing such as a resin film or a cloth may be used as the medium 92. As exemplified in FIG. 1, a liquid container 94 which retains ink is mounted in the liquid ejecting apparatus 100. For example, it is possible to use a cartridge that is attachable to and detachable from the liquid ejecting apparatus 100, a bag shape ink pack that is formed by a flexible film, or an ink tank that is able to replenish ink as the liquid container 94. A plurality of types of ink that have different colors are retained in the liquid container 94, and are supplied to a liquid ejecting head 76 via a supply pipe 96.

As exemplified in FIG. 1, the liquid ejecting apparatus 100 is equipped with a control unit 70, a transport mechanism 72, a movement mechanism 74, and the liquid ejecting head 76. For example, the control unit 70 includes a processing circuit such as a central processing unit (CPU) or a field programmable gate array (FPGA) and a storage circuit such as a semiconductor memory, and each component of the liquid ejecting apparatus 100 is comprehensively controlled. The transport mechanism 72 transports the medium 92 under control by the control unit 70.

The movement mechanism 74 moves the liquid ejecting head 76 forward and backward in a direction that intersects with (typically orthogonal to) a transport direction of the medium 92 under control by the control unit 70. The movement mechanism 74 in the first embodiment is equipped with a transport body (carriage) 742 with a substantial box shape that accommodates the liquid ejecting head 76 and an endless belt 744 to which the transport body 742 is fixed. Note that, it is also possible to mount the liquid container 94 on the transport body 742 along with the liquid ejecting head 76.

The liquid ejecting head 76 is an ink jet head that ejects ink that is supplied from the liquid container 94 onto the medium 92 from a plurality of nozzles under control by the control unit 70. In detail, the liquid ejecting head 76 is equipped with a pressure chamber and a piezoelectric element that correspond to each of the plurality of nozzles, and ejects ink that is filled into the pressure chamber from each nozzle by varying the pressure in the pressure chamber by driving each piezoelectric element by supplying a driving signal according to image data. Note that, it is also possible to utilize a heating type liquid ejecting head which uses a heat generating element that varies the pressure in the pressure chamber by generating air bubbles inside the pressure chamber by heating. A desired image is formed on a front surface of the medium 92 by the liquid ejecting head 76 ejecting ink onto the medium 92 in parallel with transport of the medium 92 by the transport mechanism 72 and repetitive forward and backward movement of the transport body 742.

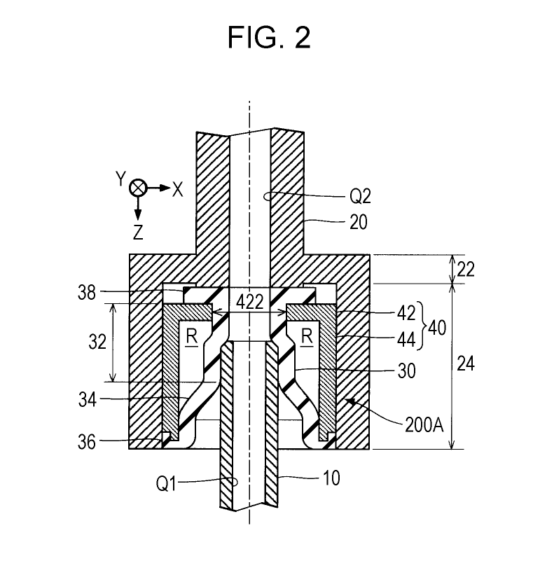

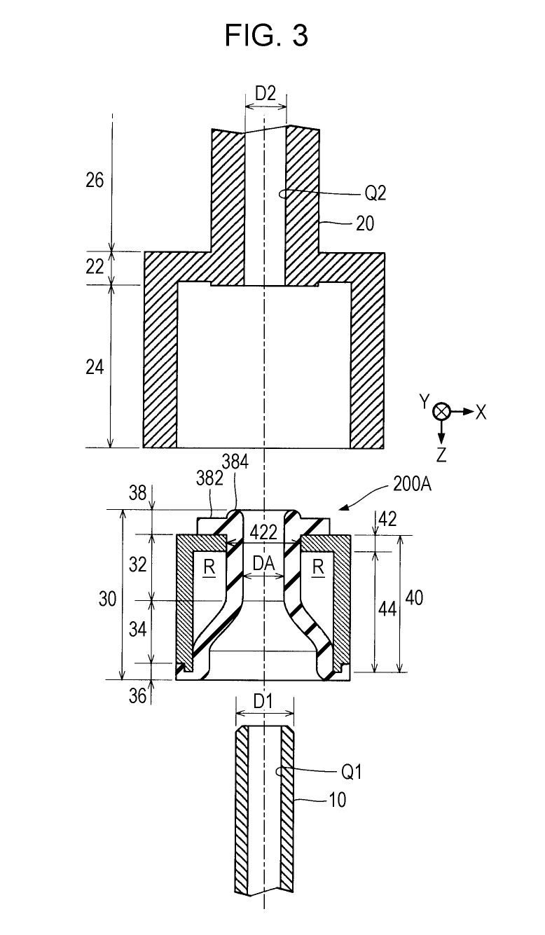

A flow path joint 200A is installed on a flow path for supplying ink that is retained in the liquid container 94 to the liquid ejecting head 76. FIG. 2 is a sectional view of the flow path joint 200A, and FIG. 3 is a sectional view of a state in which each component that is illustrated in FIG. 2 is disassembled. In the description below, a direction of a central axis of the flow path joint 200A represents a Z direction, and an X-Y plane that is perpendicular to the Z direction is assumed.

As exemplified in FIGS. 2 and 3, the flow path joint 200A is a structure for connecting a tubular body 10 and a flow path member 20. The tubular body 10 is positioned at a positive side in the Z direction with respect to the flow path member 20. The tubular body 10 is a tubular member in which a first flow path Q1 is formed internally, and the flow path member 20 is a tubular member in which a second flow path Q2 is formed internally. The flow path joint 200A in the first embodiment is a joint that connects the first flow path Q1 inside the tubular body 10 and the second flow path Q2 inside the flow path member 20 to each other.

For example, the tubular body 10 is a part of the liquid ejecting head 76. Meanwhile, the flow path member 20 is a part of the flow path unit that relays ink which is supplied from the liquid container 94 to the liquid ejecting head 76 via the supply pipe 96. For example, the flow path unit is equipped with a filter that collects foreign matter or air bubbles that are mixed in ink from the liquid container 94 or a valve mechanism for controlling opening and closing of the flow path or pressure in the flow path. Note that, it is also possible to set a part of the liquid container 94 as the flow path member 20. As understood from the above explanation, in the first embodiment, the first flow path Q1 is positioned on a downstream side of the second flow path Q2. However, the relationship of the first flow path Q1 and the second flow path Q2 (upstream/downstream) is not limited to the above example. For example, in a configuration in which a part of the flow path unit or the liquid container 94 is the tubular body 10 and a part of the liquid ejecting head 76 is the flow path member 20, the first flow path Q1 is positioned on an upstream side of the second flow path Q2. That is, representations of “first” and “second” are convenient representations for distinguishing a plurality of elements, and are not intended to represent the order or relationship between elements.

As exemplified in FIG. 3, the flow path member 20 in the first embodiment is equipped with an annular peripheral edge portion 22, a cylindrical accommodating portion 24 that projects to the positive side in the Z direction from an outer peripheral edge of the peripheral edge portion 22, and a tubular flow path portion 26 that projects to the negative side in the Z direction from the inner peripheral edge of the peripheral edge portion 22. A space inside the peripheral edge portion 22 and flow path portion 26 is the second flow path Q2. Note that, a configuration is exemplified in FIG. 3 in which the peripheral edge portion 22, the accommodating portion 24, and the flow path portion 26 are integrally formed, but it is also possible to configure the peripheral edge portion 22, the accommodating portion 24, and the flow path portion 26 separately and joined to each other.

As exemplified in FIGS. 2 and 3, the flow path joint 200A is equipped with an elastic member 30 and a support body (holder) 40. The elastic member 30 is a tubular member that is able to elastically change shape, and for example, is formed of an elastic material such as rubber or an elastomer. Meanwhile, the support body 40 is a structure that supports the elastic member 30, and is formed of a material with high rigidity in comparison to the elastic member 30 (for example, resin material or metal material). In the first embodiment, a case is assumed in which the support body 40 is formed of a material with low water content transmittance in comparison to the elastic member 30 (in particular, a press fitting portion 32 which will be described later). According to the configuration described above, it is advantageous for it to be possible to suppress spreading of water content of ink that passes through the elastic member 30 via the support body 40 (thus, thickening of ink caused by evaporation of water content). Note that, in the first embodiment, a case is exemplified where the elastic member 30 and the support body 40 are separately configured, but it is also possible to integrally form the elastic member 30 and the support body 40 (for example, two color molding).

As exemplified in FIG. 3, the support body 40 is equipped with a lid shape portion 42 and a side wall portion 44. The lid shape portion 42 is an annular plate shape part on which a circular opening portion 422 is formed in the center. The side wall portion 44 is a cylindrical part that projects to the positive side in the Z direction from the outer peripheral edge of the lid shape portion 42. As exemplified in FIGS. 2 and 3, an inner wall surface of the side wall portion 44 and an outer wall surface of the elastic member 30 face each other. Note that, in the first embodiment, a case is assumed in which the lid shape portion 42 and the side wall portion 44 are integrally formed, but it is also possible to configure the lid shape portion 42 and the side wall portion 44 separately and joined to each other.

As exemplified in FIG. 2, the support body 40 is disposed inside the accommodating portion 24 of the flow path member 20. In detail, the outer wall surface of the side wall portion 44 of the support body 40 is adhered without a gap to the inner wall surface of the accommodating portion 24 of the flow path member 20. The flow path joint 200A is fixed to the flow path member 20 by fitting the support body 40 into the accommodating portion 24 of the flow path member 20 as above.

As exemplified in FIG. 3, the elastic member 30 is equipped with the press fitting portion 32, an enlarged diameter portion 34, a holding portion 36, and a sealing portion 38. The sealing portion 38 is positioned on the negative side in the Z direction (flow path member 20 side) with respect to the press fitting portion 32, and the enlarged diameter portion 34 and the holding portion 36 are positioned at the positive side in the Z direction (tubular body 10 side) with respect to the press fitting portion 32. The enlarged diameter portion 34 is positioned between the press fitting portion 32 and the holding portion 36. Note that, in the first embodiment, a case is assumed in which the press fitting portion 32, the holding portion 36, the enlarged diameter portion 34, and the sealing portion 38 are integrally formed, but it is also possible to configure each component separately and fixed to each other. In addition, it is also possible to adopt a configuration in which the enlarged diameter portion 34 is omitted, and the press fitting portion 32 and the holding portion 36 are directly connected.

The press fitting portion 32 is a tubular part with a circular cross section. The press fitting portion 32 and the enlarged diameter portion 34 are surrounded by the side wall portion 44 of the support body 40. As understood from FIG. 3, the press fitting portion 32 is disposed at a position that is separated from the support body 40. That is, the outer wall surface of the press fitting portion 32 and the inner wall surface of the side wall portion 44 of the support body 40 face each other with a gap (space R) therebetween. The holding portion 36 is a flange shape part that protrudes from the outer wall surface of the press fitting portion 32 and the enlarged diameter portion 34 in the radial direction. The inner diameter of the holding portion 36 is a large diameter in comparison to the press fitting portion 32, and the outer diameter of the holding portion 36 is approximately the same as the outer diameter of the support body 40. As understood from FIGS. 2 and 3, the holding portion 36 is positioned at the positive side (tubular body 10 side) in the Z direction viewed from the support body 40, and engages with a step that is formed on the end surface of the side wall portion 44 of the support body 40. That is, the holding portion 36 is supported on the support body 40 (side wall portion 44) at the tubular body 10 side viewed from the press fitting portion 32. The enlarged diameter portion 34 is a tapered part in which the inner diameter increases toward the holding portion 36 from the press fitting portion 32.

The tubular body 10 is press fitted into the press fitting portion 32 via the holding portion 36 and the enlarged diameter portion 34. In detail, the tubular body 10 is inserted into the press fitting portion 32 while advancing to the negative side from the positive side in the Z direction, and is held in the state in FIG. 2 of reaching a position in the middle in the axial direction of the press fitting portion 32. An inner diameter DA of the press fitting portion 32 in a state in which the tubular body 10 is not press fitted is lower than an outer diameter D1 of the tubular body 10 (DA<D1). Accordingly, as exemplified in FIG. 2, the press fitting portion 32 changes shape by the tubular body 10 being press fitted. In detail, an interval at which the tubular body 10 out of the press fitting portion 32 is present inside is expanded in comparison to an interval in which the tubular body 10 is not present. Accordingly, the tubular body 10 is held by frictional force with the inner wall surface of the press fitting portion 32 in a state of being fastened by pressure from the press fitting portion 32.

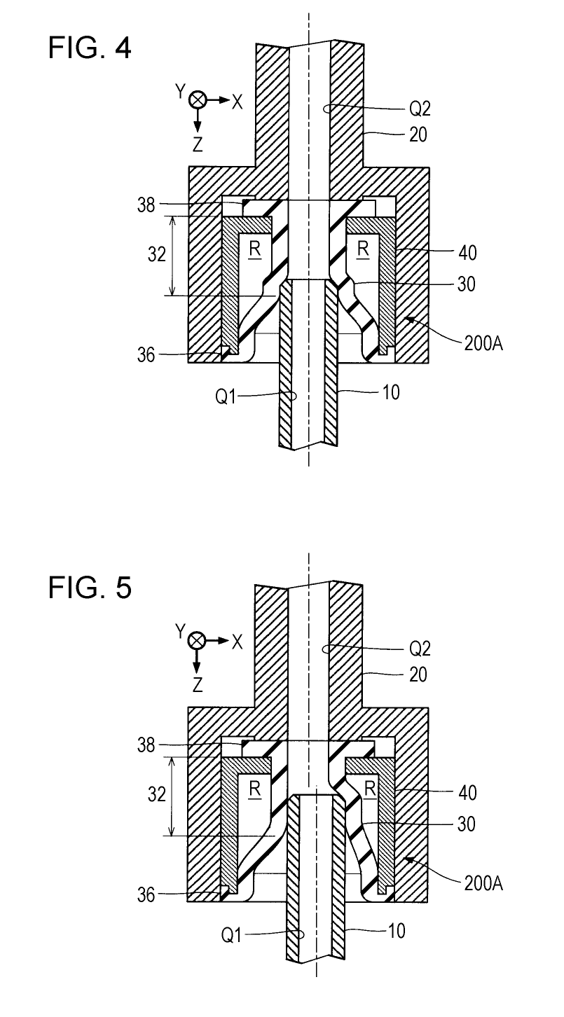

It is possible to position the tip end of the tubular body 10 at an arbitrary site between both ends of the press fitting portion 32. As exemplified in FIG. 4, for example, the tubular body 10 is held in the press fitting portion 32 even in a state in which the tip end of the tubular body 10 is positioned at the positive side in the Z direction in comparison to FIG. 2 (state in which an amount of press fitting is small). As understood from the above explanation, a positional error in the Z direction of the tubular body 10 with respect to the flow path member 20 (or the flow path joint 200) is absorbed by the press fitting portion 32 of the elastic member 30.

As exemplified in FIG. 2, the end portion on the negative side in the Z direction out of the press fitting portion 32 (the flow path member 20 side) is inserted into the opening portion 422 of the lid shape portion 42 of the support body 40. The outer diameter of the press fitting portion 32 in a state in which the tubular body 10 is not press fitted is a substantially equal diameter or slightly larger diameter than the inner diameter of the opening portion 422 of the lid shape portion 42. Accordingly, the outer wall surface of the press fitting portion 32 and the inner wall surface of the lid shape portion 42 are adhered to each other without a gap. As understood from the above explanation, the space R between the outer wall surface of the press fitting portion 32 and the inner wall surface of the side wall portion 44 of the support body 40 is sealed. That is, the space R is not substantially linked to external air. Accordingly, it is advantageous for it to be possible to effectively suppress spreading of ink that passes through the elastic member 30 externally.

The sealing portion 38 is installed on the end portion on the negative side in the Z direction out of the press fitting portion 32. As exemplified in FIG. 2, the sealing portion 38 is interposed between the support body 40 and the flow path member 20. In detail, the sealing portion 38 is interposed between the front surface on the negative side in the Z direction out of the lid shape portion 42 of the support body 40 and the front surface on the positive side in the Z direction out of the peripheral edge portion 22 of the flow path member 20. As exemplified in FIG. 3, the sealing portion 38 in the first embodiment includes a base portion 382 and a projecting portion 384. The base portion 382 is an annular plate shape part that protrudes from the outer wall surface of the press fitting portion 32 in a direction that is parallel to the X-Y plane. The front surface on the positive side in the Z direction out of the base portion 382 is adhered to the front surface on the negative side in the Z direction out of the lid shape portion 42 of the support body 40. The interval at which the tubular body 10 is not present inside the press fitting portion 32 (that is, an interval on the negative side in the Z direction viewed from the tip end of the tubular body 10) and the base portion 382 have an equal inner diameter DA. That is, the inner wall surface of the elastic member 30 is continuous over the base portion 382 and the press fitting portion 32.

As exemplified in FIG. 3, a difference between the inner diameter of the press fitting portion 32 (inner diameter in a state in which the tubular body 10 is not press fitted) DA and an inner diameter D2 of the second flow path Q2 (DA−D2) is lower than the difference between an outer diameter D1 of the tubular body 10 and the inner diameter DA of the press fitting portion 32 (D1−DA) (DA−D2<D1−DA). For example, the inner diameter DA of the press fitting portion 32 and the inner diameter D2 of the second flow path Q2 are substantially equal (DA=D2). That is, as exemplified in FIG. 2, the inner wall surface of the elastic member 30 (the press fitting portion 32 and the sealing portion 38) is continuous to the inner wall surface of the second flow path Q2 of the flow path member 20 without a step. In a case where there is a difference between the inner diameter DA of the press fitting portion 32 and the sealing portion 38 and the inner diameter D2 of the second flow path Q2, it is possible for a problem to occur in that air bubbles that are mixed in the ink tend to be retained in a step because of the difference. In the first embodiment, since a difference between the inner diameter DA of the press fitting portion 32 and the inner diameter D2 of the second flow path Q2 is suppressed, it is possible to reduce a possibility that air bubbles are retained in a step that is caused by the difference. Note that, the inner diameter D2 of the second flow path Q2 has a meaning of the inner diameter of a part that contacts the elastic member 30 out of the second flow path Q2.

The projecting portion 384 of the sealing portion 38 that is exemplified in FIG. 3 is a part that projects from the front surface on the opposite side from the press fitting portion 32 out of the base portion 382 and contacts the flow path member 20. The projecting portion 384 in the first embodiment is formed in an annular shape along an inner peripheral edge of the base portion 382 viewed from the Z direction, and a cross section parallel to the Z direction is an arc shape (for example, a semicircular shape) projection. As understood from FIG. 2, the projecting portion 384 changes shape in response to pressing from the peripheral edge portion 22 of the flow path member 20 in a state in which the sealing portion 38 is interposed between the support body 40 and the flow path member 20. That is, the sealing portion 38 functions as a sealing portion that seals between the support body 40 and the flow path member 20.

As understood from the above explanation, a space inside the elastic member 30 is linked to the second flow path Q2 of the flow path member 20 in a state in which the flow path joint 200A is fixed to the flow path member 20. Accordingly, the first flow path Q1 of the tubular body 10 and the second flow path Q2 of the flow path member 20 are linked to each other via the elastic member 30 by press fitting the tubular body 10 into the press fitting portion 32. That is, as described above, the flow path joint 200A functions as a joint that links the first flow path Q1 and the second flow path Q2 to each other. As exemplified in FIG. 2, a central axis of the tubular body 10 and a central axis of the flow path member 20 match each other in an ideal state in which there is no positional error between the tubular body 10 and the flow path member 20.

As explained above, in the first embodiment, it is possible for the press fitting portion 32 to change shape according to the position of the tubular body 10 since the press fitting portion 32 into which the tubular body 10 out of the elastic member 30 is press fitted is disposed at a position that is separated from the support body 40. Accordingly, positional error of the tubular body 10 with respect to the flow path member 20 (second flow path Q2) is absorbed because of the change of shape of the press fitting portion 32. For example, a case is exemplified in FIG. 5 in which there is a difference in the position of the tubular body 10 with respect to the flow path member 20 (a case where the central axis of the tubular body 10 is positioned on the positive side in the X direction viewed from the central axis of the flow path member 20). As exemplified in FIG. 5, even in a state in which the central axis of the tubular body 10 and the central axis of the flow path member 20 do not match each other, the first flow path Q1 of the tubular body 10 and the second flow path Q2 of the flow path member 20 are appropriately linked by changing the shape of the press fitting portion 32 so as to follow the position of the tubular body 10 on the X-Y plane. That is, according to the first embodiment, it is possible to enlarge the permissible range of the positional error of the tubular body 10 with respect to the second flow path Q2 (error in a direction that is parallel to the X-Y plane).

Note that, in a step in which the tubular body 10 is press fitted into the press fitting portion 32 of the elastic member 30, external pressure toward the negative side in the Z direction acts on the elastic member 30 from the tubular body 10. In the first embodiment, it is advantageous for it to be possible to suppress buckling of the elastic member 30 when the tubular body 10 is press fitted into the press fitting portion 32 since the holding portion 36 of the elastic member 30 is supported on the support body 40 at the tubular body 10 side (positive side in the Z direction) viewed from the press fitting portion 32. Note that, from the viewpoint described above such that the press fitting portion 32 changes shape following the positional error of the tubular body 10 with respect to the flow path member 20, a configuration in which the elastic member 30 tends to change shape is suitable, but there is a tendency that buckling of the elastic member 30 tends to be generated during press fitting of the tubular body 10 the more the elastic member 30 tends to change shape (that is, rigidity is low). According to the first embodiment, it is advantageous for it to be possible to both favorably suppress buckling of the elastic member 30 and absorb the positional error of the tubular body 10 with respect to the flow path member 20.

In addition, in the first embodiment, a gap between the elastic member 30 and the flow path member 20 is reduced since the sealing portion 38 of the elastic member 30 is interposed between the support body 40 and the flow path member 20. Accordingly, it is advantageous for it to be possible to suppress retention of air bubbles in a part that connects the first flow path Q1 and the second flow path Q2.

### Second Embodiment

A second embodiment of the invention will be described. Note that, in each of the aspects exemplified below, concerning components which have the same actions and functions as the first embodiment, detailed explanation will be omitted as appropriate by using the same reference numerals which are explained in the first embodiment.

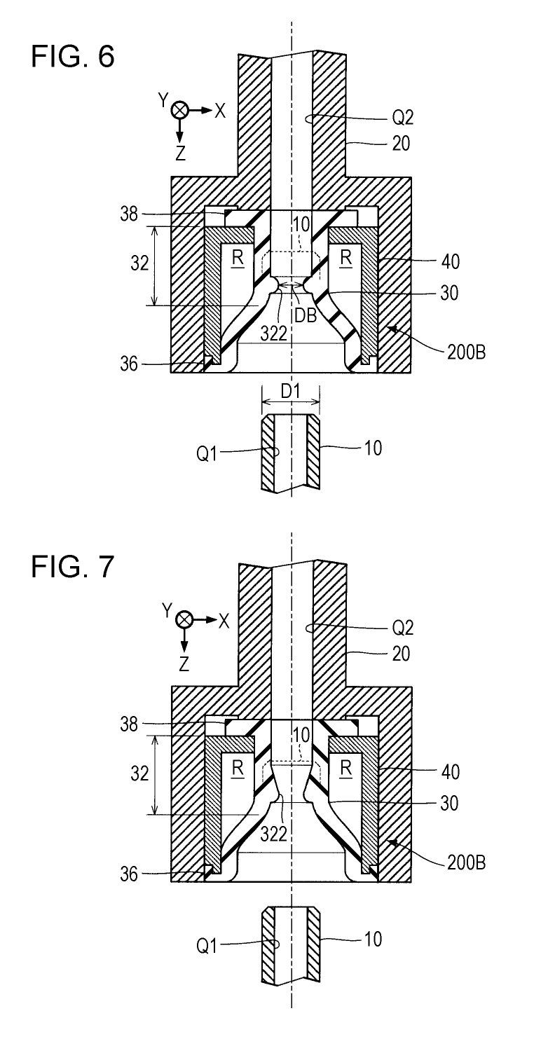

FIG. 6 is a sectional view of a flow path joint 200B in the second embodiment. A state prior to press fitting of the tubular body 10 with respect to the elastic member 30 is exemplified in FIG. 6. As exemplified in FIG. 6, the elastic member 30 of the second embodiment is equipped with a pipe internal projecting portion 322 that is added to elements that are similar to in the first embodiment. The pipe internal projecting portion 322 is a projection that is formed on the inner wall surface of the press fitting portion 32. The pipe internal projecting portion 322 in the first embodiment is formed in an annular shape along a peripheral direction of the press fitting portion 32 viewed from the Z direction, and a cross section is an arc shape (for example, a semicircular shape) projection. An inner diameter DB of the elastic member 30 on the upper surface of the pipe internal projecting portion 322 is lower than the outer diameter D1 of the tubular body 10. In the pipe internal projecting portion 322, the inner diameter out of the press fitting portion 32 may also be said to be a small part in comparison to another part.

As illustrated by a broken line in FIG. 6, in the second embodiment, the tubular body 10 is press fitted into the press fitting portion 32 such that the tip end of the tubular body 10 reaches the negative side in the Z direction viewed from the pipe internal projecting portion 322. Accordingly, the pipe internal projecting portion 322 changes shape by pressing using the outer wall surface of the tubular body 10. That is, the pipe internal projecting portion 322 functions as a sealing portion that seals between the outer wall surface of the tubular body 10 and the inner wall surface of the press fitting portion 32.

Similar effects to those in the first embodiment are also realized in the second embodiment. In addition, in the second embodiment, it is possible to secure sealability between the elastic member 30 and the tubular body 10 while suppressing external force that is necessary in press fitting of the tubular body 10 with respect to the press fitting portion 32 since the pipe internal projecting portion 322 is formed on the inner wall surface of the press fitting portion 32.

Note that, the inner diameter of a part other than the pipe internal projecting portion 322 out of the press fitting portion 32 has a substantially equal to or slightly smaller diameter than the outer diameter D1 of the tubular body 10. In the configuration described above, the inner wall surface of the part other than the pipe internal projecting portion 322 out of the press fitting portion 32 is adhered to the outer wall surface of the tubular body 10 without a gap. Accordingly, it is possible to reduce a possibility that the gap in which air bubbles may be retained is formed between the press fitting portion 32 and the tubular body 10. In addition, the inner diameter of the part other than the pipe internal projecting portion 322 out of the press fitting portion 32 is a larger diameter in comparison to the inner diameter DB in the pipe internal projecting portion 322. Accordingly, it is possible to easily insert the tubular body 10 into the press fitting portion 32 by reducing friction of the part other than the pipe internal projecting portion 322 with the outer wall surface of the tubular body 10 while securing sealability of the outer wall surface of the tubular body 10 using the pipe internal projecting portion 322.

Note that, a cross section in FIG. 6 exemplifies the arc shape pipe internal projecting portion 322, it is possible to appropriately modify the shape of the pipe internal projecting portion 322. As exemplified in FIG. 7, for example, it is also possible to form the pipe internal projecting portion 322 of a shape that combines an inclined surface that is inclined in the Z direction and an arc surface.

### Third Embodiment

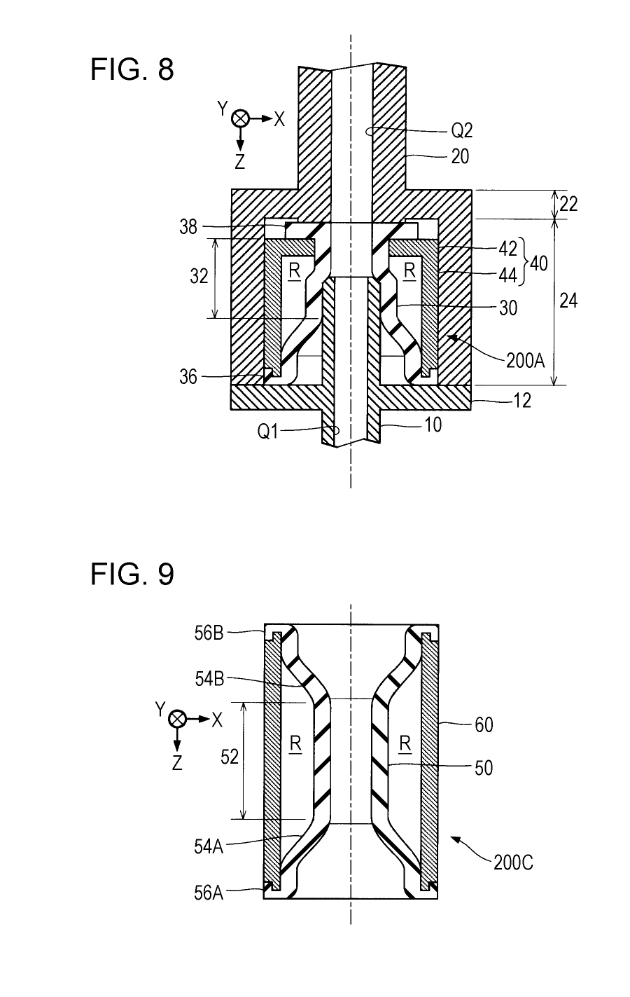

FIG. 8 is a sectional view in a third embodiment. In the third embodiment, the flow path joint 200A is used in the same manner as in the first embodiment. As exemplified in FIG. 8, a flange portion (flange) 12 is formed on the tubular body 10 in the third embodiment. The flange portion 12 is an annular plate shape part that protrudes from the outer wall surface of the tubular body 10 in a direction that is parallel to the X-Y plane. The external form of the flange portion 12 is larger than the outer diameter of the holding portion 36 out of the elastic member 30. In detail, the outer diameter of the flange portion 12 is substantially equal to the outer diameter of the accommodating portion 24 of the flow path member 20. As exemplified in FIG. 8, the front surface on the negative side in the Z direction out of the flange portion 12 abuts with the end surface on the positive side in the Z direction out of the accommodating portion 24 of the flow path member 20 and the front surface on the positive side in the Z direction out of the holding portion 36 of the elastic member 30. In the state described above, the holding portion 36 of the elastic member 30 is interposed between the end surface on the tubular body 10 side out of the side wall portion 44 of the support body 40 and the flange portion 12 of the tubular body 10.

In a step in which the tubular body 10 is press fitted into the press fitting portion 32, the tubular body 10 stops advancing at a step at which the front surface on the negative side in the Z direction out of the flange portion 12 abuts with the end surface on the positive side in the Z direction out of the side wall portion 44 of the support body 40 and the front surface on the positive side in the Z direction out of the holding portion 36 of the elastic member 30. That is, movement of the tubular body 10 in the Z direction is regulated by the flange portion 12 abutting with the accommodating portion 24 of the flow path member 20 and the holding portion 36 of the elastic member 30. Accordingly, it is advantageous for it to be possible to manage with high precision the amount of press fitting of the tubular body 10 into the press fitting portion 32.

In addition, the elastic member 30 is accommodated in a space that is surrounded by the accommodating portion 24 and the flange portion 12 in a state in which the flange portion 12 of the tubular body 10 abuts with the accommodating portion 24 of the flow path member 20. Accordingly, it is also advantageous for it to be possible to suppress spreading of ink that passes through the elastic member 30 externally. Note that, the pipe internal projecting portion 322 that is exemplified in the second embodiment may also be formed in the same manner as the press fitting portion 32 of the elastic member 30 in the third embodiment.

### Fourth Embodiment

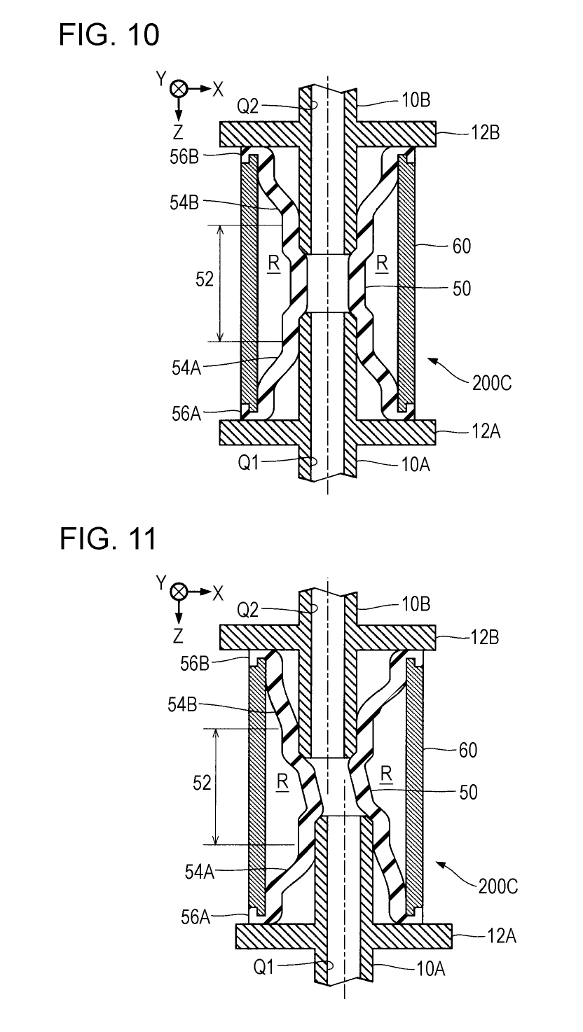

FIG. 9 is a sectional view of a flow path joint 200C in the fourth embodiment, and FIG. 10 is an explanatory diagram of a state in which the flow path joint 200C is used. As exemplified in FIG. 10, the flow path joint 200C in the fourth embodiment is a joint that connects the first flow path Q1 inside a first tubular body 10A and the second flow path Q2 inside the second tubular body 10B. For example, one of the first tubular body 10A and the second tubular body 10B is a part of the liquid ejecting head 76, and the other of the first tubular body 10A and the second tubular body 10B is a part of the flow path unit. Note that, it is not considered if either of the first flow path Q1 and the second flow path Q2 is positioned on the upstream side. An annular flange portion 12A that protrudes from the outer wall surface of the first tubular body 10A in a direction that is parallel to the X-Y plane is formed on the first tubular body 10A. In the same manner, an annular flange portion 12B that protrudes from the outer wall surface of the second tubular body 10B is formed on the second tubular body 10B.

As exemplified in FIGS. 9 and 10, the flow path joint 200C in the fourth embodiment is equipped with an elastic member 50 and a support body 60. The support body 60 has a cylindrical structure that accommodates and supports the elastic member 50 in the same manner as the support body 40 in each aspect described above, and for example, is formed of a resin material or a metal material. Note that, it is also possible to integrally form the elastic member 50 and the support body 60 (for example, two color molding).

In the same manner as in the elastic member 30 in each aspect described above, the elastic member 50 is a tubular member that is able to elastically change shape, and for example, is formed of an elastic material such as rubber or an elastomer. As exemplified in FIGS. 9 and 10, the elastic member 50 in the fourth embodiment is a substantially tubular member that includes the press fitting portion 52, an enlarged diameter portion 54A, a holding portion 56A, an enlarged diameter portion 54B, and a holding portion 56B. Note that, it is also possible to configure each component of the elastic member 50 separately and fixed to each other.

The press fitting portion 52 is a tubular part with a circular cross section. In the same manner as in each aspect described above, the press fitting portion 52 is disposed at a position that is separated from the support body 60. That is, the outer wall surface of the press fitting portion 52 and the inner wall surface of the support body 60 face each other with a gap (space R) therebetween. The holding portion 56A is positioned on the positive side in the Z direction viewed from the press fitting portion 52, and the holding portion 56B is positioned on the negative side in the Z direction viewed from the press fitting portion 52. The enlarged diameter portion 54A is a tapered part in which the inner diameter increases toward the holding portion 56A from the press fitting portion 52, and the enlarged diameter portion 54B is a tapered part in which the inner diameter increases toward the holding portion 56B from the press fitting portion 52.

As understood from FIG. 9, the holding portion 56A engages with a step that is formed on the end surface on the positive side in the Z direction out of the support body 60. That is, the holding portion 56A is supported on the support body 60 at the first tubular body 10A side viewed from the press fitting portion 52. In the same manner, the holding portion 56B engages with a step that is formed on the end surface on the negative side in the Z direction out of the support body 60. That is, the holding portion 56B is supported on the support body 60 at the second tubular body 10B side viewed from the press fitting portion 52.

The first tubular body 10A is press fitted into the press fitting portion 52 via the holding portion 56A and the enlarged diameter portion 54A from the positive side toward the negative side in the Z direction. In a process in which the first tubular body 10A is press fitted, the first tubular body 10A stops advancing at a point in time at which the flange portion 12A of the first tubular body 10A abuts with the holding portion 56A of the elastic member 50. That is, the holding portion 56A of the elastic member 50 is interposed between the end surface on the positive side in the Z direction out of the support body 60 and the flange portion 12A of the first tubular body 10A.

In the same manner, the second tubular body 10B is press fitted into the press fitting portion 52 from the negative side toward the positive side in the Z direction via the holding portion 56B and the enlarged diameter portion 54B, and the second tubular body 10B stops advancing at a point in time at which the flange portion 12B of the second tubular body 10B abuts with the holding portion 56B of the elastic member 50. That is, the holding portion 56B of the elastic member 50 is interposed between the end surface on the negative side in the Z direction out of the support body 60 and the flange portion 12B of the second tubular body 10B. As understood from the above explanation, in the fourth embodiment, the elastic member 50 is accommodated and supported in a cylindrical space that is surrounded by the support body 60, the flange portion 12A, and the flange portion 12B. Note that, a configuration in which the press fitting portion 52 changes shape in response to press fitting of the first tubular body 10A and the second tubular body 10B is the same as in each aspect described above.

In the fourth embodiment, it is possible for the press fitting portion 52 to change shape according to the position of the first tubular body 10A and the second tubular body 10B since the press fitting portion 52 into which the first tubular body 10A and the second tubular body 10B out of the elastic member 50 are press fitted is disposed at a position that is separated from the support body 60. Accordingly, positional error between the first tubular body 10A and the second tubular body 10B is absorbed because of the change of shape of the press fitting portion 52. For example, a case where there is positional error between the first tubular body 10A and the second tubular body 10B is exemplified in FIG. 11. As exemplified in FIG. 11, even in a state in which the central axis of the first tubular body 10A and the central axis of the second tubular body 10B do not match each other, the first flow path Q1 of the tubular body 10 and the second flow path Q2 of the flow path member 20 are appropriately linked by changing the shape of the press fitting portion 52 so as to follow the position of the first tubular body 10A and the second tubular body 10B on the X-Y plane. That is, according to the first embodiment, it is possible to enlarge the permissible range of the positional error between the first flow path Q1 and the second flow path Q2.

### Modification Examples

It is possible for each aspect which is exemplified above to be variously modified. Specific modified aspects will be exemplified below. It is possible to appropriately combine two or more aspects which are arbitrarily selected from the below exemplifications within a range which is not mutually inconsistent.

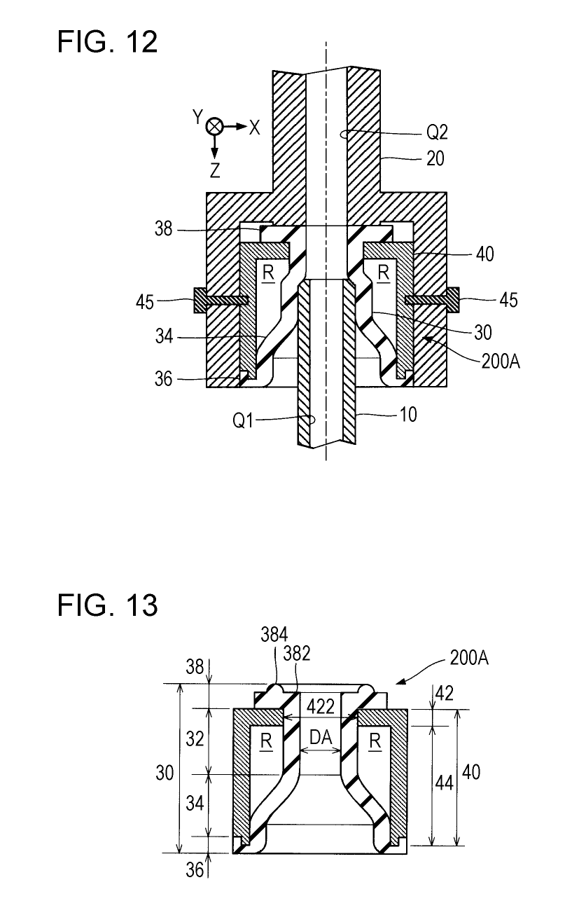

(1) In the first embodiment to the third embodiment, a configuration in which the support body 40 fits into the accommodating portion 24 of the flow path member 20 is exemplified, but as exemplified in FIG. 12, it is also possible to install a fixing portion 45 for fixing the flow path member 20 and the support body 40 to each other. The fixing portion 45 that is exemplified in FIG. 12 passes through the accommodating portion 24 of the flow path member 20, and is a screw that is fixed in the side wall portion 44 of the support body 40. In addition to the screw that is exemplified in FIG. 12, it is possible to use various elements such as an adhesive or thermal caulking for fixing the support body 40 and the flow path member 20 as the fixing portion. In addition, it is also possible to fix the support body 40 and the flow path member 20 to each other by engaging a screw groove that is formed on the outer wall surface of the side wall portion 44 of the support body 40 and a screw groove that is formed on the inner wall surface of the accommodating portion 24 of the flow path member 20.

(2) In the first embodiment to the third embodiment, a configuration is exemplified in which the sealing portion 38 out of the elastic member 30 is formed by the annular projecting portion 384 along the inner peripheral edge of the base portion 382, but the position of the projecting portion 384 in the sealing portion 38 is not limited to the exemplifications described above. For example, as exemplified in FIG. 13, it is also possible to install the annular projecting portion 384 at a position that is separated from the inner peripheral edge of the base portion 382 (for example, a position along a part in the middle in a radial direction or the outer peripheral edge).

(3) In each aspect described above, a serial type liquid ejecting apparatus 100 that moves a transport body 742 on which the liquid ejecting head 76 is mounted forward and backward is exemplified, but it is also possible to apply the invention to a line type liquid ejecting apparatus that distributes a plurality of nozzles across the entire width of the medium 92.

(4) It is possible to adopt the liquid ejecting apparatus 100 which is exemplified in each of the aspects described above in various devices other than a device which is specialized for printing such as a facsimile apparatus or a copy machine. However, the applications of the liquid ejecting apparatus of the invention are not limited to printing. For example, a liquid ejecting apparatus which ejects color liquid is utilized as a manufacturing apparatus which forms a color filter of a liquid crystal display apparatus. In addition, a liquid ejecting apparatus which ejects a conductive material solution is utilized as a manufacturing apparatus which forms an electrode and a wiring of a wiring substrate.

(5) An apparatus in which the flow path joint 200 (200A, 200B, and 200C) that is exemplified in each aspect described above is used is not limited to the liquid ejecting apparatus 100. That is, it is possible to use the flow path joint 200 that is exemplified in each aspect described above in an arbitrary configuration in which the first flow path Q1 and the second flow path Q2 are connected to each other.

This application claims priority under 35 U.S.C. §119 to Japanese Patent Application No. 2016-107344, filed May 30 2016. The entire disclosure of Japanese Patent Application No. 2016-107344 is hereby incorporated herein by reference.

What is claimed is:

1. A flow path joint, which connects a first flow path inside a tubular body to a second flow path inside a flow path member, comprising:
an elastic member that is elastically deformable; and
a support body that supports the elastic member,
wherein the elastic member includes
a press fitting portion which is a tubular shape part that is to be linked to the second flow path and into which the tubular body is press fitted, and
a sealing portion that is interposed between the support body and the flow path member.

2. The flow path joint according to claim 1,
wherein the elastic member includes a pipe internal projecting portion that is formed on the inner wall surface of the press fitting portion along a peripheral direction of the press fitting portion.

3. The flow path joint according to claim 1 further comprising:
a fixing portion for fixing the support body and the flow path member.

4. The flow path joint according to claim 1,
wherein a difference between an inner diameter of the press fitting portion and an inner diameter of the second flow path is lower than a difference between an outer diameter of a part that is press fitted into the press fitting portion out of the tubular body and the inner diameter of the press fitting portion.

5. The flow path joint according to claim 1,
wherein the sealing portion includes
a base portion that projects from an outer wall surface of the press fitting portion, and
a projecting portion that projects from a front surface on the opposite side from the press fitting portion out of the base portion and that contacts the flow path member.

6. The flow path joint according to claim 1,
wherein the press fitting portion is disposed at a position that is separated from the support body, and
the elastic member includes a holding portion that is supported on the support body at the tubular body side viewed from the press fitting portion.

7. A liquid ejecting apparatus comprising:
a liquid ejecting head which ejects liquid;
a tubular body on which a first flow path is formed for supplying the liquid to the liquid ejecting head; and
a flow path joint that connects a second flow path internal to a flow path member to the first flow path,
wherein the flow path joint includes
an elastic member that is elastically deformable, and
a support body that supports the elastic member, and
the elastic member includes
a press fitting portion which is a tubular shape part that is to be linked to the second flow path and into which the tubular body is press fitted, and
a sealing portion that is interposed between the support body and the flow path member.

8. The flow path joint according to claim 2 further comprising:
a fixing portion for fixing the support body and the flow path member.

9. The flow path joint according to claim 2,
wherein a difference between an inner diameter of the press fitting portion and an inner diameter of the second flow path is lower than a difference between an outer diameter of a part that is press fitted into the press fitting portion out of the tubular body and the inner diameter of the press fitting portion.

10. The flow path joint according to claim 2,
wherein the sealing portion includes
a base portion that projects from an outer wall surface of the press fitting portion, and
a projecting portion that projects from a front surface on the opposite side from the press fitting portion out of the base portion and that contacts the flow path member.

11. The flow path joint according to claim 2,
wherein the press fitting portion is disposed at a position that is separated from the support body, and
the elastic member includes a holding portion that is supported on the support body at the tubular body side viewed from the press fitting portion.

12. The flow path joint according to claim 3,
wherein a difference between an inner diameter of the press fitting portion and an inner diameter of the second flow path is lower than a difference between an outer diameter of a part that is press fitted into the press fitting portion out of the tubular body and the inner diameter of the press fitting portion.

13. The flow path joint according to claim 3,
wherein the sealing portion includes
a base portion that projects from an outer wall surface of the press fitting portion, and
a projecting portion that projects from a front surface on the opposite side from the press fitting portion out of the base portion and that contacts the flow path member.

14. The flow path joint according to claim 3,
wherein the press fitting portion is disposed at a position that is separated from the support body, and
the elastic member includes a holding portion that is supported on the support body at the tubular body side viewed from the press fitting portion.

15. The flow path joint according to claim 4,
wherein the sealing portion includes
a base portion that projects from an outer wall surface of the press fitting portion, and
a projecting portion that projects from a front surface on the opposite side from the press fitting portion out of the base portion and that contacts the flow path member.

16. The flow path joint according to claim 4,
wherein the press fitting portion is disposed at a position that is separated from the support body, and
the elastic member includes a holding portion that is supported on the support body at the tubular body side viewed from the press fitting portion.

17. The flow path joint according to claim 5,
wherein the press fitting portion is disposed at a position that is separated from the support body, and
the elastic member includes a holding portion that is supported on the support body at the tubular body side viewed from the press fitting portion.
